(19) United States
(12) Patent Application Publication
(10) Pub. No.: US 2009/0239419 A1
(43) Pub. Date: Sep. 24, 2009

(54) Connector header with wire wrap pins

(76) Inventor: Steve R. Chamuel, Danvers, MA (US)

Correspondence Address: OSRAM SYLVANIA INC, 100 ENDICOTT STREET, DANVERS, MA, 01923, US

(21) Appl. No.: 12/077,345

(22) Filed: Mar. 18, 2008

(51) Int. Cl. H01R 24/00

(52) U.S. Cl. 439/629

(57) ABSTRACT

A connector header (10) is provided. The connector header includes an electrically insulating body (12), having an upper surface (14) and an opposed lower surface (16), separated by end walls (18) and side walls (20). At least two projections (22) are formed on said lower surface (16). At least one electrically conducting wire wrap pin (24) is fixed in said electrically insulating body (12), projects beyond said lower surface (16), and has an exposed surface (24a) adjacent said upper surface (14). The connector header also includes a solder relieving feature (26) formed with at least one of said end walls (18) or side walls (20).

### TECHNICAL FIELD

This invention relates to headers and more particularly to headers deploying an array of wire wrap terminal for insertion into printed circuit boards.

### BACKGROUND ART

Wire wrap terminals can be inserted into printed circuit boards manually; however, this procedure is time consuming an expensive.

### DISCLOSURE OF INVENTION

Therefore, it is an object of the invention to obviate the disadvantages of the prior art.

It is another object of the invention to enhance the operation of headers.

It is another object of the invention to improve printed circuit board headers.

These objects are accomplished, in one aspect of the invention, by the provision of a connector header comprising: an electrically insulating body having opposed upper and lower surfaces separated by end walls and side walls; at least two projections formed on said lower surface; at least one electrically conducting wire wrap pin fixed in said electrically insulating body and projecting beyond said lower surface; and a solder relieving feature formed with at least one of said end walls or side walls. This connector header is easily adaptable to automatic insertion in printed circuit boards.

### BRIEF DESCRIPTION OF THE DRAWINGS

FIG. 1 is a perspective view of an embodiment of the invention;

FIG. 2 is a sectional view taken along the line 2-2 of FIG. 1;

FIG. 3 is a partial perspective view of an alternate embodiment;

FIG. 4 is a plan view of yet another alternate embodiment;

FIG. 5 is a sectional view taken along the line 5-5 of FIG. 4;

FIG. 6 is a sectional view taken along the line 6-6 of FIG. 4;

FIG. 7 is a partial, perspective view of an alternate construction; and

FIG. 8 is an elevation view, in section, of yet another alternate construction.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

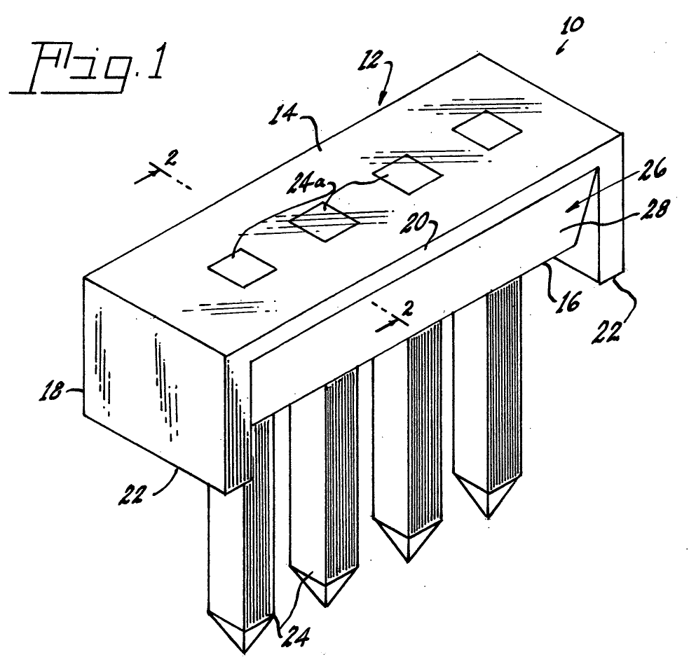

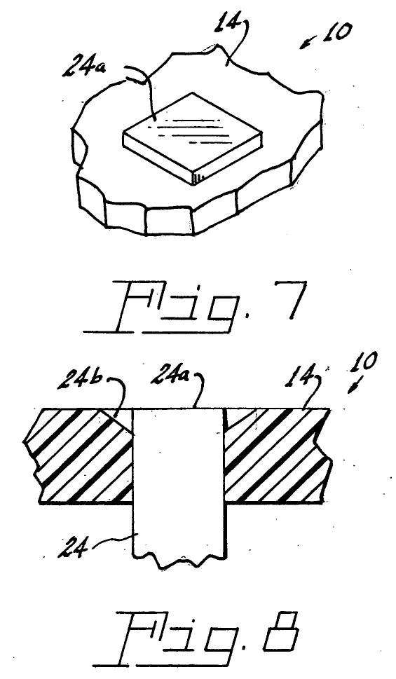

Referring now to the drawings with greater particularity, there is shown in FIG. 1 a connector header 10 comprising: an electrically insulating body 12 having an upper surface 14 and an opposed lower surface 16, separated by end walls 18 and side walls 20. The header body 12 is preferably formed from a material that can accept the heat of a soldering operation. Such materials include, but are not limited to high heat plastics and other dielectric materials. At least two projections 22 are formed on the lower surface 16. The projections 22 extend at lease slightly beyond the lower surface 16 to provide a set-off for the header body 12. At least one electrically conducting wire wrap pin 24 is fixed in the electrically insulating body 12 and projects beyond the lower surface 16. A top 24a of the wire wrap pin 24 is exposed to receive electrical contacts. The top 24a of the pin 24 can be flush with the upper surface 14, raised slightly above the surface 14, as shown in FIG. 7, or be provided with a surrounding recesses 24b, as shown in FIG. 8. A solder relieving feature 26 is formed with at least one of the end walls 18 or side walls 20. In a preferred embodiment of the invention the solder relieving feature 26 comprises a chamfer 28 beginning at the upper surface 14 (or closely adjacent thereto) and terminating at the lower surface 16.

The header body 12 can take many different configurations. For example, the body 12 can be rectangular, with relatively square corners, as shown in FIG. 1 or the ends can be rounded, as shown in FIG. 2.

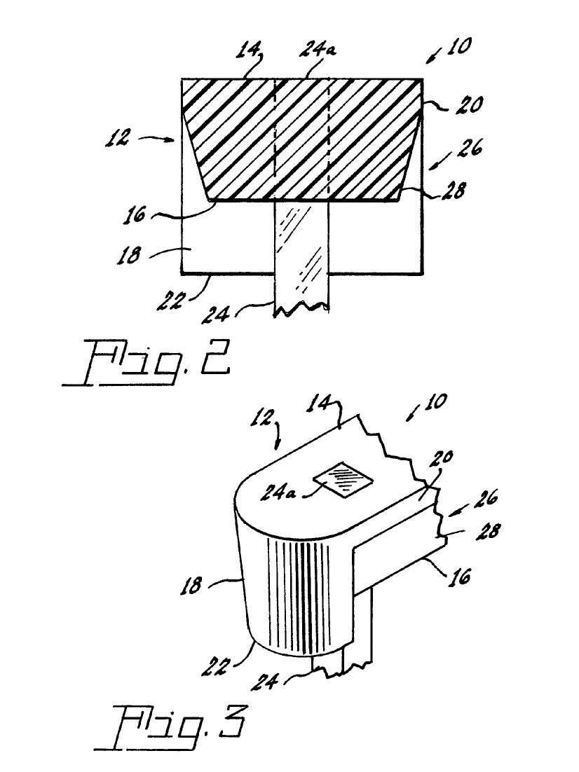

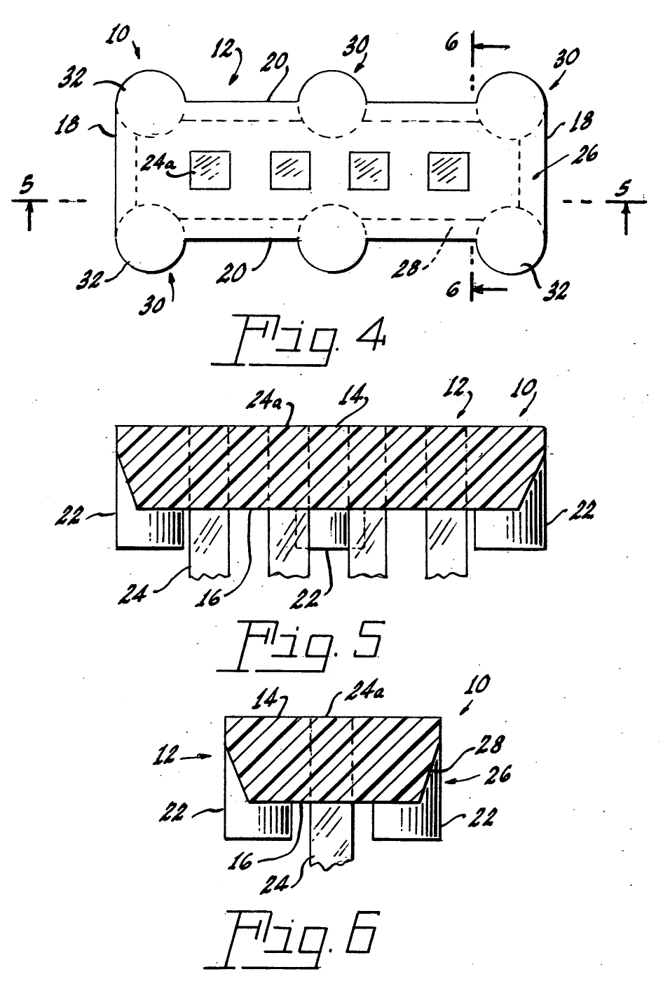

An additional embodiment is shown in FIG. 3-6 where the side walls 20 are provided with scalloped edges 30. In this particular embodiment each of the projections 22 is aligned with a scallop bulge 32.

Thus there is provided a connector header that is ideally suited to printed circuit board insertion.

While there have been shown and described what are at present considered to be the preferred embodiments of the invention, it will be apparent to those skilled in the art that various changes and modifications can be made herein without departing from the scope of the invention as defined by the appended claims.

1. A connector header comprising:
an electrically insulating body having opposed upper and lower surfaces separated by end walls and side walls;
at least two projections formed on said lower surface;
at least on electrically conducting wire wrap pin fixed in said electrically insulating body and projecting beyond said lower surface and having an exposed top on said upper surface; and
a solder relieving feature formed with at least one of said end walls or side walls.

2. The connector header of claim 1 wherein said solder relieving feature comprises a chamfer beginning at said upper surface and terminating at said lower surface.

3. The connector header of claim 2 wherein said electrically insulating body is resistant to temperatures generated by applicable solders.

4. The connector header of claim 1 wherein said side walls are scalloped.

5. The connector header of claim 4 wherein said at least two projections on said lower surface comprise six projections.

6. The connector header of claim 5 wherein each of said projections is aligned with a scallop bulge.

7. The connector header of claim 1 wherein said at least two projections are associated with said end walls.
